(19) United States
(12) Patent Application Publication
(10) Pub. No.: US 2016/0230573 A1
(43) Pub. Date: Aug. 11, 2016

(54) STEAM TURBINE DIFFUSER CONFIGURATION

(71) Applicant: ALSTOM Technology Ltd., Baden (CH)

(72) Inventor: Brian Robert HALLER, Lincolnshire (GB)

(21) Appl. No.: 15/008,523

(22) Filed: Jan. 28, 2016

(30) Foreign Application Priority Data
Feb. 5, 2015 (EP) 15154023.4

(51) Int. Cl. F01D 9/02; F01D 25/30

(52) U.S. Cl. CPC F01D 9/02; F01D 25/30; F05D 2220/31; F05D 2250/71; F05D 2240/24; F05D 2240/30

(57) ABSTRACT

The invention relates to a turbine diffuser for recovering pressure from a fluid exhausted from a last stage blade, the diffuser. In at least in a region between 10% of the longitudinal length and of the diffuser and a downstream end of the diffuser, the inner guide forms an inflectionless curve and further has a peak radial height at a point between 40%-60% of the longitudinal length.

### CROSS-REFERENCE TO RELATED APPLICATIONS

This application claims priority to European Patent application 15154023.4 filed Feb. 5, 2015, the contents of which are hereby incorporated in its entirety.

### TECHNICAL FIELD

The present disclosure relates to general to steam turbine configurations and more specifically to configurations and arrangements of pressure recovery diffusers located between steam turbine last stages and exhaust hoods that lead discharged steam typically to a condenser.

### BACKGROUND

In condensing steam turbines used in power generation, steam exiting the last row of turbine blades flows through a diffuser which is an outwardly flared passage, positioned between the turbine enclosure, or casing, and an exhaust hood. Such diffusers are defined by an outwardly flared flow guide extending from the turbine casing, to which it is customarily fastened, for 360 degrees circumferentially about the turbine shaft, and an inner flow guide formed at least in part by the outer surface of the bearing cone or in some cases a separate flow guide. The steam passes from the diffuser into the body of a collector or “exhaust hood” and subsequently discharges from the exhaust hood into a condenser. The most prevalent type of exhaust hood is one located directly above the condenser, or a “downward-discharging” exhaust hood.

The purpose of a diffuser is to lower the steam pressure at the turbine exit and thus to increase the amount of energy available to the turbine and also to improve the performance of the last blades of the turbine even when condenser pressure is higher than the design pressure which occurs when the temperature of the condenser cooling water becomes higher than that assumed in the design of the turbine. As a result of increasing cross-sectional area, diffusion, or decelerating, occurs as the exhaust steam passes through the diffuser. This deceleration causes a decrease in the kinetic energy of the steam plus an increase in pressure, wherein the net effect is that the inlet to the diffuser assumes the lowest pressure of the path from the turbine to the condenser so that the steam exhausts from the last turbine blades into a minimum pressure zone thus increasing the velocity of steam flowing through the blades and increasing the energy available to the turbine to do work.

It is desirable for the diffuser to produce a large pressure rise so as to lead to a low entrance pressure to the diffuser and thus at the exit from the last row of turbine blades as this increases the energy available to the turbine to do work and also improves the performance of the last row of blades. However, the amount of diffusion a diffuser can produce is limited by the (longitudinal) pressure gradient along the diffuser, which is generally defined as the ratio of the pressure rise to the length of the diffuser. Such pressure rise in turn typically depends on the exit-to-inlet area ratio of the diffuser. If the pressure gradient becomes too large, i.e. the walls of the diffuser diverge too steeply, the steam flow will become separated from the walls of the diffuser and the amount of diffusion can be seriously reduced or even entirely eliminated.

There is therefore a continuing need for diffuser geometries that achieve the aim of improved pressure recovery.

U.S. Pat. No. 6,261,055 describes a diffuser geometry for improved pressure recovery based on the concept of a non-linear increase in cross-sectional area. In particularly, this discussion relates to a diffuser in which at a distance of one half of the diffuser length, the cross-sectional area increase is not large than 5% of the cross-sectional area at the inlet.

### SUMMARY

A steam turbine diffuser is disclosed can improve pressure recovery at the discharge of a steam turbine.

It attempts to addresses this problem by means of the subject matters of the independent claims. Advantageous embodiments are given in the dependent claims.

One general aspect includes a steam turbine diffuser for recovering pressure from steam exhausted from a last stage blade. The diffuser has an upstream end at the last stage blade, a downstream and a longitudinal length extending from the upstream end to the downstream end. The diffuser also includes an inner guide, extending between the upstream end and the downstream end, and an outer guide, extending between the upstream end and the downstream end, radially displaced from the inner guide so as to from a flow passage therebetween.

In this aspect at least in a region between 10% of the longitudinal length and the downstream end, the inner guide has an inflectionless curve with a peak radial height at a point between 40%-60% of the longitudinal length.

In an aspect the turbine diffuser has a diffusor cross sectional area, taken from perpendicularly from a mean line extending between the inner guide and the outer guide. For a circularly uniform diffusers the area may be calculated using the formula;

A=π*(r(outer)²r(inner)²

In this aspect, between the upstream end and the peak height, the cross sectional area varies by less than 15%.

Further aspects may include one or more of the following features. The inner guide and outer guide configured and arranged relative to each other such that, extending from the upstream end to about 20% of the longitudinal length, a diffuser cross sectional area, decreases. The diffusor cross sectional area, taken from perpendicularly from a mean line extending between the inner guide and outer guide wherein between the upstream end and the peak height, the cross sectional area varies by less than 15%. The inner guide and the outer guide are configured and arranged relative to each other such that, extending from the upstream end to between 3% and 5% of the longitudinal length, the diffuser cross sectional area, increases. The inner guide and the outer guide configured and arranged relative to each other such that, extending between 10% and 20% of the longitudinal length, the diffuser cross sectional area, decreases.

The diffuser wherein between 20% of the longitudinal length and the downstream end, the outer guide forms an inflectionless curve having a tangent line outside the flow passage. The outer guide having a point of inflection between 10%-20% of the longitudinal length.

Other aspects and advantages of the present disclosure will become apparent from the following description, taken in connection with the accompanying drawings which by way of example illustrate exemplary embodiments of the present invention.

### BRIEF DESCRIPTION OF THE DRAWINGS

By way of example, an embodiment of the present disclosure is described more fully hereinafter with reference to the accompanying drawings, in which:

FIG. 1 is a schematic of a steam turbine section including a diffuser according to an exemplary embodiment of the disclosure;

FIG. 2 is a chart showing a cross sectional area ratio of the diffuser along an axial length of the diffuser of FIG. 1; and

FIG. 3 is a chart showing a cross sectional area ratio of the diffuser along an axial length of another exemplary embodiment.

### DETAILED DESCRIPTION

Exemplary embodiments of the present disclosure are now described with references to the drawings, wherein like reference numerals are used to refer to like elements throughout. In the following description, for purposes of explanation, numerous specific details are set forth to provide a thorough understanding of the disclosure. However, the present disclosure may be practiced without these specific details, and is not limited to the exemplary embodiment disclosed herein.

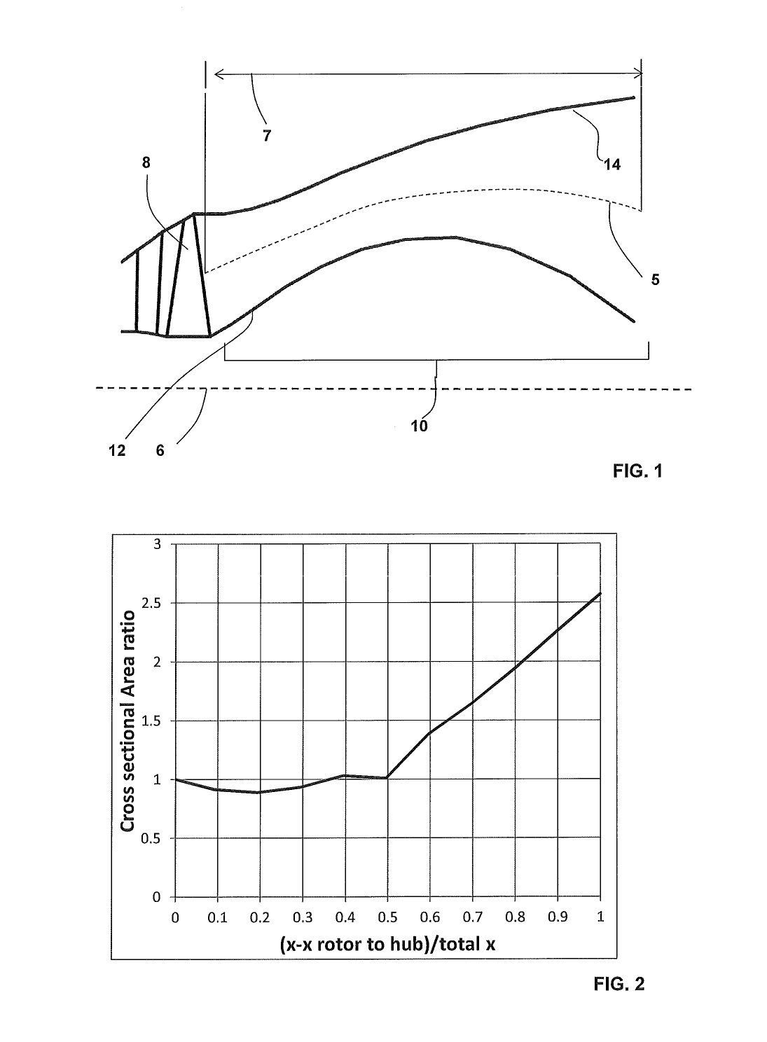

An exemplary embodiment, shown in FIG. 1, is a steam turbine diffuser 10 for recovering pressure from steam exhausted from a last stage blade 8 of the steam turbine before the steam enters an exhaust hood/ collector. The diffuser 10 circumscribes a longitudinal axis 6 of rotation of the steam turbine. The diffuser 10 has an inner guide 12 that extends along the longitudinal axis 6 and has an upstream end (9) at the last stage blade 8 and a distal downstream end 11 at the exhaust hood/collector. Complementing the inner guide 12 is an outer guide 14 that extends along the longitudinal axis 6 and is radially displaced from the inner guide 12 to form a diffuser passage with a cross sectional area defined as a perpendicular from a mean line 5 extending between the inner guide 12 and outer guide 14. The outer guide 14 has, common with the inner guide 12, an upstream end 9 at the last stage blade and a distal downstream end 11 at the exhaust hood/collector.

The a diffuser additionally has longitudinal length 7 extending from a diffuser first end at a point between the upstream end 9 of the inner guide 12 and upstream end 9 of the outer guide along a mean line 5 extending between the inner guide and outer guide to a point between the downstream end 11 of the inner guide and the downstream end 11 of the outer guide 14.

In an exemplary embodiment the inner guide 12 and outer guide 14 are configured such that a cross section area of the first end is less than a cross sectional area of the second end, while in the transition region between the ends of the diffuser 10 and the inner guide 12 forms an inflectionless curve with a peak radial height, measured as a distance from the rotational I axis of the turbine, at a point between 40%-60% of the diffuser longitudinal length 7. FIG. 2 shows the cross sectional area of the exemplary embodiment of a diffuser shown in FIG. 1. As shown in FIG. 2, in an exemplary embodiment, during the first 20% of the longitudinal length 7 of the diffuser 10, the cross sectional area decreases. The decrease is a function of the relative curvature of the inner guide 12 and the outer side. For example, in an exemplary embodiment shown in FIG. 1, the outer guider 13 has a point of inflection in the regions of 10%-20% of the longitudinal length 7 of the diffuser while thereafter extends either in a curve or straight segments without any inflection points.

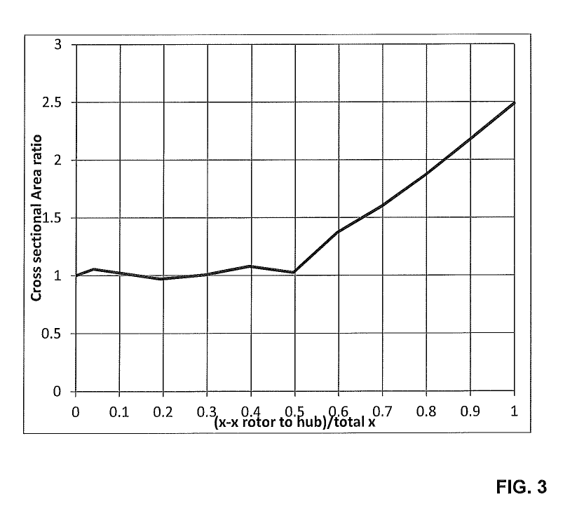

In exemplary embodiment shown in FIG. 3 the inner guide 12 and the outer guide 14 are configured and arranged relative to each other such that, extending from the upstream end 9 to between 3% and 5% of the longitudinal length 7, the diffuser 10 cross sectional area, increases. This may be advantageous when it is desirable to maintain the reaction rate of the last stage blades. After this initial period extending between 10% and 20% of the longitudinal length 7, the diffuser 10 cross sectional area decreases.

Although the disclosure has been herein shown and described in what is conceived to be the most practical exemplary embodiment, the present disclosure can be embodied in other specific forms. The presently disclosed embodiments are therefore considered in all respects to be illustrative and not restricted. The scope of the disclosure is indicated by the appended claims rather that the foregoing description and all changes that come within the meaning and range and equivalences thereof are intended to be embraced therein.

1. A steam turbine diffuser for recovering pressure from a fluid exhausted from a last stage blade, the diffuser having:
an upstream end at the last stage blade;
a downstream end;
a longitudinal length extending from the upstream end to the downstream end;
an inner guide, extending between the upstream end and the downstream end; and
an outer guide, extending between the upstream end and the downstream end, radially displaced from the inner guide so as to form a flow passage therebetween,
wherein, at least in a region between 10% of the longitudinal length and the downstream end, the inner guide forming an inflectionless curve and further has a peak radial height at a point between 40%-60% of the longitudinal length.

2. The steam turbine diffuser of claim 1 having a diffusor cross sectional area, taken from perpendicularly from a mean line extending between the inner guide and outer guide wherein between the upstream end and the peak height, the cross sectional area varies by less than 15%.

3. The steam turbine diffuser of claim 2 wherein the inner guide and the outer guide are configured and arranged relative to each other such that, extending from the upstream end to 20% of the longitudinal length, the diffuser cross sectional area decreases.

4. The steam turbine diffuser of claim 2 wherein the inner guide and the outer guide are configured and arranged relative to each other such that, extending from the upstream end to between 3% and 5% of the longitudinal length, the diffuser cross sectional area increases.

5. The steam turbine diffuser of claim 2 wherein the inner guide and the outer guide are configured and arranged relative to each other such that, extending between 10% and 20% of the longitudinal length, the diffuser cross sectional area decreases.

6. The steam turbine diffuser of claim 1 wherein the outer guide, between 30% of the longitudinal length to the downstream end, forms an inflectionless curve having a tangent line outside the flow passage.

7. The steam turbine diffuser of claim 3 wherein the outer guide, between 30% of the longitudinal length to the downstream end, forms an inflectionless curve having a tangent line outside the flow passage.

8. The steam turbine diffuser of claim 3 wherein the outer guide has a point of inflection at between 10%-20% of the longitudinal length.
